(19) United States
(12) Patent Application Publication
(10) Pub. No.: US 2006/0038690 A1
(43) Pub. Date: Feb. 23, 2006

(54) Geographic location monitor

(76) Inventors: Gary Shmerling, Atlanta, GA (US); Dori Rath, Palmetto, FL (US); Robert Berry, Canton, GA (US); Tyler Shewmake, Myakka City, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/125,007

(22) Filed: May 9, 2005

Related U.S. Application Data
(60) Provisional application No. 60/602,135, filed on Aug. 17, 2004.

(51) Int. Cl. G08B 23/00; G08B 1/00

(52) U.S. Cl. 340/576; 340/531

(57) ABSTRACT

Embodiments of the present disclosure provide systems and methods for monitoring a driver of a vehicle. Briefly described, in architecture, one embodiment of the system, among others, includes a first reporting means for receiving a communication from a person regarding the driving behavior of the driver of the vehicle. In addition, the system includes a second reporting means for delivering the communication to a user monitoring the driving behavior of the driver. Other systems and methods are also provided.

### CROSS-REFERENCE TO RELATED APPLICATION

This application claims priority to copending U.S. provisional application entitled, “Geographic Location Monitor,” having Ser. No. 60/602,135, filed Aug. 17, 2004, which is entirely incorporated herein by reference.

### COPYRIGHT NOTICE

A portion of the disclosure of this patent document contains material that is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present disclosure is generally related to information reported from hardware devices and navigational systems, processed by information systems, and subsequently relayed to end-users.

### BACKGROUND

Current “location based services” (LBS) allow a user to monitor the location, speed and direction of a hardware device using the Global Positioning System (GPS). Typically, the hardware device, which may be a hard wired or portable “black box”, or a GPS enabled cell phone, etc., uses software to convert a GPS data stream from the device to coordinates on a map and to otherwise interpolate the “lat/lon” (latitude longitude) data and its changes over time. In addition, graphic displays can be shown on a user's computer to show the location coordinates. For example, an application service provider (ASP) often uses common mapping engines (such as MapQuest®) and other interpolation tools to generate and display the desired information to a user's computer from an ASP's Internet site.

It is well known that hardware devices located in or within vehicles are capable of reporting a variety of data to navigational systems, which can then be processed and relayed to end-users by information systems. Recently, mapping and other interpolated GPS data have been wirelessly delivered to a user's compatible GPS cell phone. While these embodiments are powerful, the data that they report can only be made available to users who have access to a computer or other Internet enabled device, or have a compatible GPS enabled cell phone which is accessible to an active cell tower. As such, any data that can be processed and reported can only be reported or relayed in limited ways and through limited channels.

Currently the industry supports a limited number of data communication channels for relaying this critical data to end-users. Thus, a heretofore unaddressed need exists to enable end-users to receive and access the data available from hardware and navigational reporting systems in broader and more accessible channels

### SUMMARY

Embodiments of the present disclosure provide systems and methods for monitoring a driver of a vehicle. Briefly described, in architecture, one embodiment of the system, among others, includes a first reporting means for receiving a communication from a person regarding the driving behavior of the driver of the vehicle. In addition, the system includes a second reporting means for delivering the communication to a user monitoring the driving behavior of the driver.

Embodiment of the present disclosure can also be viewed as providing methods for monitoring a driver of a vehicle. In this regard, one embodiment of such a method, among others, can be broadly summarized by the following steps: receiving a driving report on the driver of the vehicle from a person observing the driver, the driving report including a description of the driving behavior of the driver; and delivering the driving report on the driver to a user monitoring the driver

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment, among others, of a system for providing location-based services.

FIGS. 2A-2C are flowcharts describing one embodiment, among others, of a driver monitoring program utilizing the system of FIG. 1

FIGS. 3A-3B are flowcharts describing one embodiment, among others, of a process for making a report for the driver monitoring program using the system of FIG. 1.

FIGS. 4A-4B are flowcharts describing one embodiment, among others, of a process for notifying a user that a report has been received by the driver monitoring program utilizing the system of FIG. 1.

FIGS. 5A-5C are flowcharts describing one embodiment, among others, of a process for requesting a report from the driver monitoring program utilizing the system of FIG. 1.

### DETAILED DESCRIPTION

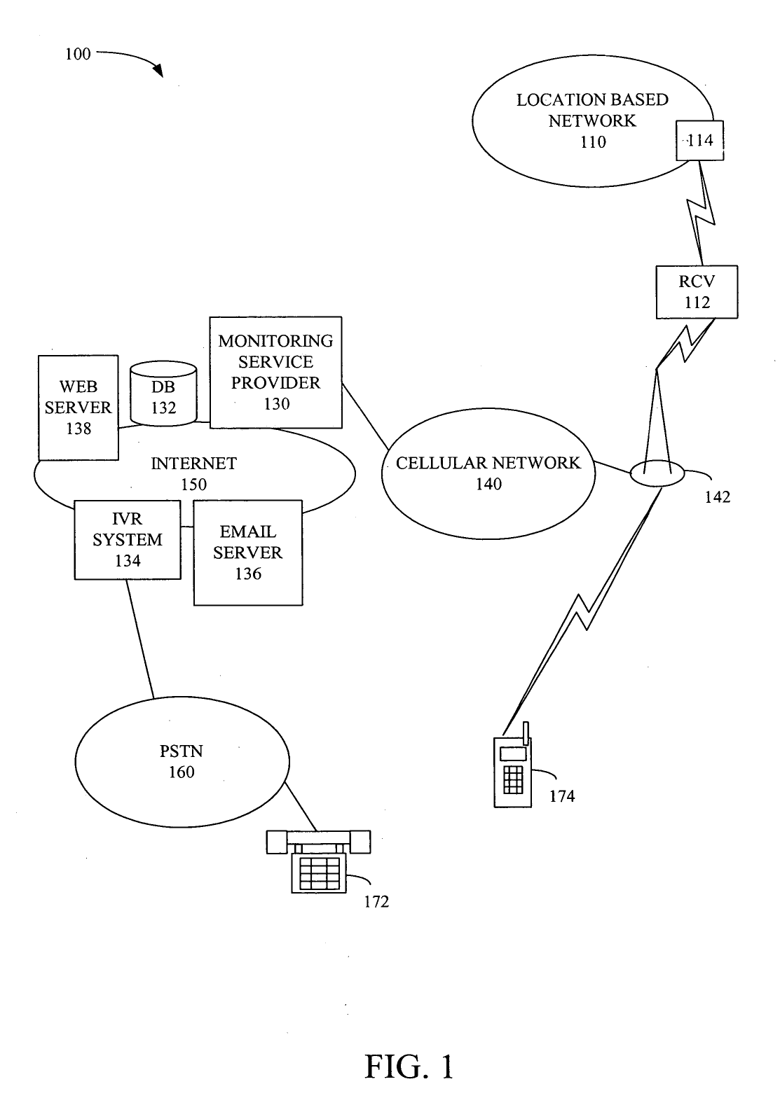

FIG. 1 shows one embodiment, among others, of a system 100 for providing location-based services (“LBS system”). As shown by FIG. 1, a location-based network 110, such as the Global Positioning System (GPS), is provided. Typically, in a location-based network 110, such as GPS, a receiver 112 receives signals from satellites 114 in the sky and determines its location on Earth from these signals by employing a trilateration technique. In the present system, the receiver 112 communicates its location to a monitoring service provider 130 via a cellular communications network 140. For this purpose, the receiver 112 is capable of communicating with the communications network 140. In some embodiments, the receiver 112 is loaded with a JAVA application that notifies a cell tower 142 via cellular communications, on a regular basis, the current location of the receiver 112. This information is relayed to the monitoring service provider 130 and stored in a database 132. The database 132 is typically accessible from a communication network, such as the Internet 150.

Therefore, to learn the whereabouts of a person possessing the receiver 112, a concerned party can place a telephone call (e.g., over a public-switched telephone network (PSTN) 160 or cellular network 140) to an interactive voice response (IVR) system 134 maintained by the monitoring service provider 130. The IVR system 134 has access to the database 132. Thus, the IVR system 134 is capable of taking the most recent location data describing the location of the receiver 112 (that is stored in the database 132); translating the location data to voice or speech; and describing the current location in a spoken report to the concerned party. The IVR system 134 can thus promptly report the location of the receiver 112 to any user who has access to a telephone, whether land line 172 or cellular 174, and calls the monitoring service provider (via a toll-free number, for example). Further, in some embodiments, the IVR system 134 communicates with users utilizing electronic messages (e.g., e-mail) via an e-mail server 136 and web-based communications via web server 138.

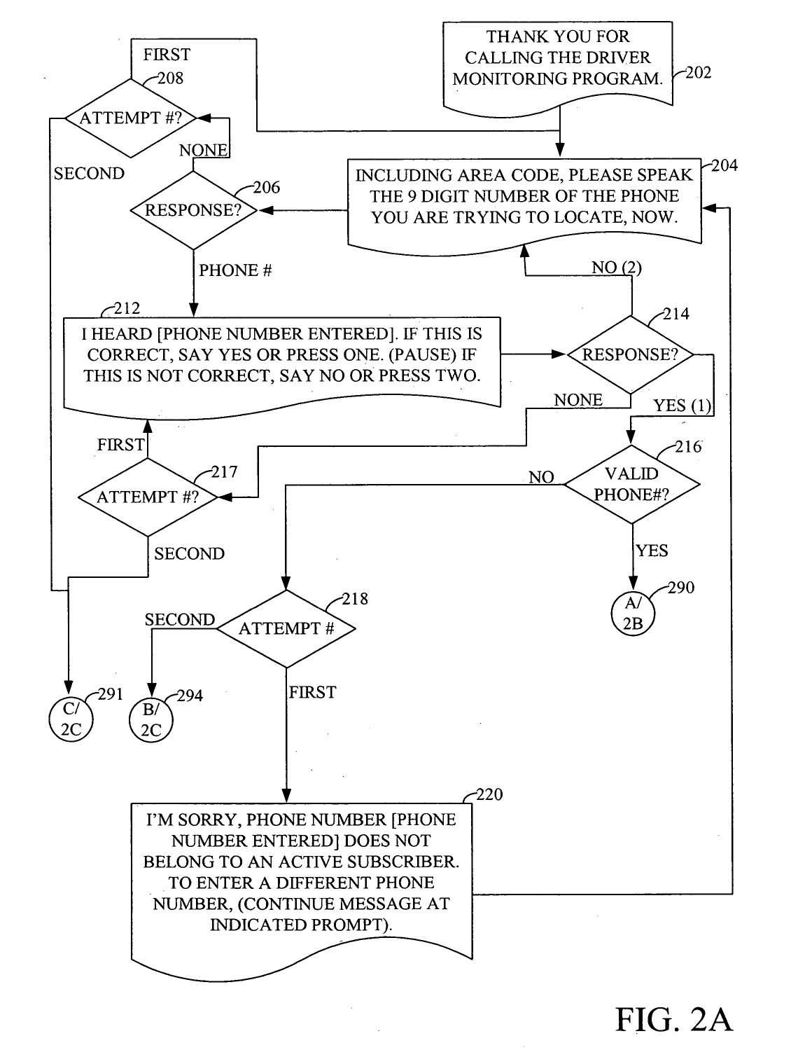

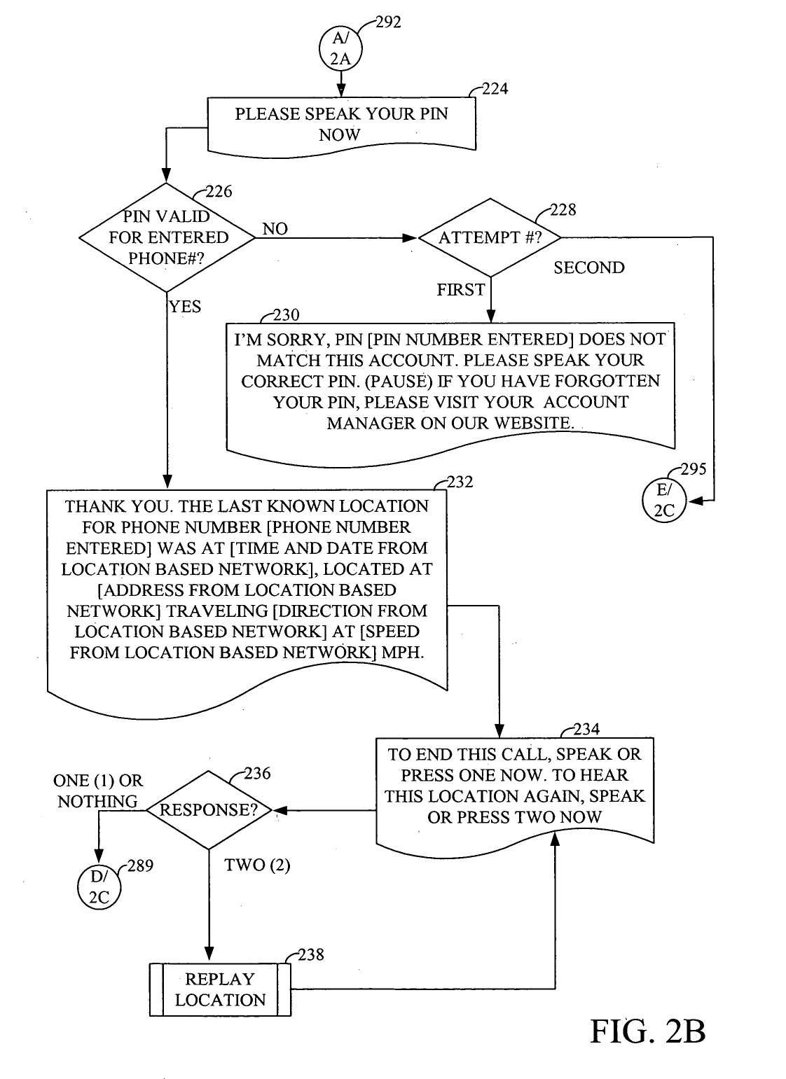

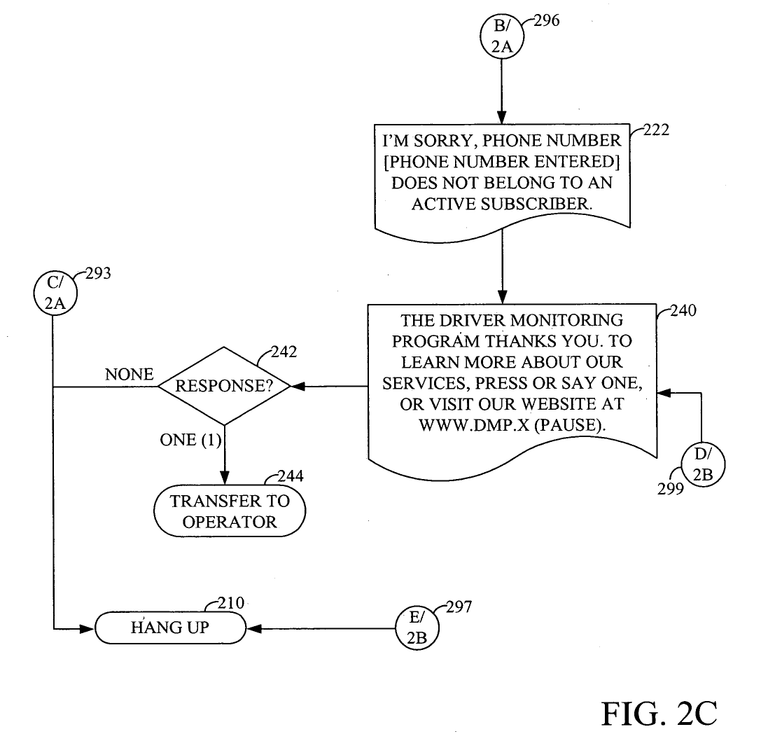

FIGS. 2A-2C are flowcharts describing one embodiment, among others, of a driver monitoring program utilizing the IVR system 134 of FIG. 1. For this particular embodiment, the driver monitoring program allows motorists to report aberrant driving behavior of drivers in vehicles bearing a decal with a unique identification number, -by calling in a report to a toll-free telephone number listed on the decal. Reports from motorists are received by a programmed IVR system 134, which interfaces with the reporting caller. The IVR system 134 records an audio report, provided by the caller, as a WAV file (or some other file format) and promptly notifies a user, such as a parent of the driver, of the report by an IVR-generated telephone message and/or via an automatically generated email message via e-mail server 136 of FIG. 1.

As a participant of this particular type of monitoring program, a user, such as a parent, can have peace of mind knowing that other concerned motorists can now let the user know, at any time, how a participant driver (e.g., a user's child) is driving, for example. By attaching a bumper decal with its own unique number to an automobile, for example, a user can be notified when a report of driving behavior is received on the automobile's decal—no matter where the user is or what the user is doing. This provides the user an opportunity to immediately counsel a driver of the automobile before dangerous driving behavior becomes deadly. Advantageously, driving behavior is also significantly improved by the act of affixing a decal to a car's bumper, as driving behavior is no longer anonymous.

The aforementioned driver monitoring program provides parents and other users with tools and support needed to recognize, address and modify driving behavior. As a result, drivers who know they're being monitored tend to drive more safely. In addition, inexperienced drivers benefit when corrective measures and counseling are the result of common driving errors, rather than accidents. A monitored driver also benefits by being promptly alerted (e.g., immediately alerted, in some embodiments) to a potentially dangerous situation and offered the opportunity to modify their driving behavior before an accident occurs. By addressing driving behavior promptly, accidents can be avoided, and the development of bad driving habits can be prevented.

As an added feature of the driver monitoring program, some embodiments, employ location-based network technology, such as GPS technology, to provide the user the ability to locate a driver (e.g., user's child) possessing a receiver 112 at anytime and place. For example, as a user of the driver monitoring program, a user can hear a description of the current location of a participant driver (including street name, street number, city, and state), by using a phone or in another embodiment, by accessing a sound file containing the audio description over the Internet. For some embodiments, the location of a participant driver can be performed in real time.

In some embodiments, the receiver 112 is a GPS-enabled cell phone, such as a Motorola® i730 cell phone. Accordingly, the LBS system 100 provides speed, location, direction, or other data generated by or based on the location of the GPS-enabled cell phone. To provide location data, a small JAVA application is typically installed on the GPS-enabled cell phone and is configured to communicate with a cell tower, on a regular basis, when the phone is not being used in conversation. Accordingly, while the GPS-enabled cell phone is being used, location tracking is suspended. However, the GPS-enabled cell phone provides update location information after the call is completed. Some embodiments of the present disclosure employ services by uLocate® Communications of Newton Center, Mass., to provide GPS data for GPS-enabled cell phones.

For some embodiments, at the user's option, the IVR system 134 can also notify the driver/possessor of a cell phone that a report has been made on him or her, via an IVR-generated phone call, SMS (Short Messaging Service) message, or a programmed, IVR specific “ring tone” on the cell phone of the recipient. The user can also retrieve (listen to) the WAV file report through the IVR system, or via a web site maintained by the driver monitoring program. In most instances, a user can receive an immediate report notification and should generally receive a report notification within a minute or two of its submission. As mentioned previously, the LBS system 100 employs an algorithm to determine an estimated speed. This speed estimate is typically accurate. There are, however, many environmental and system factors involved which may affect accuracy.

For some embodiments, the driver monitoring program sets up member accounts for users of the program. To set up an account, an interested person may register for an account from a website maintained by the driver monitoring program. After registering, additional instructions may also be provided on the website (of the driver monitoring program) for activating a user's decal, configuring the user account, and setting up user notifications, etc., in some embodiments. The user notifications are the phone numbers, email addresses, etc. that the IVR system 134 uses to notify the user about a new report that has been received for the user's decal number. However, if for some reason the user notifications are unable to be delivered to the user, the user can still access the new report by accessing the user's account from the driver monitoring program website.

As stated, when a report is typically received for a decal assigned to a user's account, the IVR system 134 processes the notification rules that were provided by the user during registration or via subsequent configurations in the user's account settings. Up to three phone numbers and six email addresses will be notified, in some embodiments, in near real-time of the report. Various options may also be made available for report retrieval, such as listening to the report at the time the user is first notified; calling the retrieval telephone line for the driver monitoring program; and going online and logging in to the website of the driver monitoring program to access the sound (WAV) files for both the report and the contact information.

Referring back to FIGS. 2A-2C, one embodiment of a process for requesting and receiving location information is presented. Starting at step 202, a user calls the IVR system 134 using a landline or wireless telephone (via a toll-free number, for example), and the IVR system 134 plays an audio greeting to the user, such as “Thank you for calling the Driver Monitoring Program.” The IVR system 134 prompts (204) the user to provide the phone number of the GPS-enabled cell phone 112 about which the user is interested in receiving location information. For some embodiments, the user can respond via voice commands or by entering the number via a keypad of the user's telephone 172, 174. Accordingly, the IVR system 134 waits (206) for the user's response for a set time period. After the time period has elapsed and no response has been received, the system 134 prompts the user to provide the telephone number of the GPS-enabled cell phone of interest, for the case of a first failed attempt, as shown in step 208. Otherwise, the system hangs up (210).

If a response is received from the user, the IVR system 134 repeats the received phone number back to the user and asks the user to confirm that the telephone number was received correctly, as shown in step 212, by pressing or vocally stating a requested phrase (such as saying “yes” or “no” or pressing “1” or “2”), for example. If the IVR system 134 receives a response indicating that the received telephone number is not correct, the IVR system 134 prompts the user to provide the desired telephone number again, as shown in step 214. Alternatively, either the IVR system 134 receives the correct telephone number and proceeds to step 216, or the IVR system 134 receives a non-valid response and proceeds to step 217.

In step 216, the IVR system 134 verifies that the telephone number, provided by the user, is a valid phone number of a GPS-enabled cell phone 112 that has been previously registered with the driver monitoring program. In step 217, the IVR system 134 prompts the user to confirm the received telephone number, for a first failed attempt. Otherwise, the system hangs up (210) (after transitioning from point C/2C (291) in FIG. 2A to point C/2A (293) in FIG. 2C).

If the phone number provided by the user is not a registered phone number, the IVR system 134 prompts the user to enter a different telephone number, as shown in steps 218-220, for a first failed attempt at verifying the entered phone number. Otherwise, the IVR system 134 notifies the user that the phone number does not belong to a participant of the driver monitoring program, as shown in steps 218 and 222 (after moving from FIG. 2A to 2C by transitioning from point B/2C (294) to point B/2A (296))

Alternatively, if the phone number provided by the user is verified by the IVR system 134, the user is prompted in step 224 (after moving from FIG. 2A to 2B by transitioning from point A/2B (290) to point A/2A (292)) to provide a personal identification number (PIN) to verify the user as being authorized to access information related to the verified telephone number. If the PIN number provided by the user does not match (226) the PIN number registered by the driver monitoring program, the user is notified that the PIN number that the user provided does not match the PIN number associated with the verified telephone number, as shown in steps 228-230, for a first failed attempt at providing the PIN number. Accordingly, the user is prompted to provide the PIN number again. Otherwise, if this is the second failed attempt at providing the PIN number, the IVR system 134 terminates the telephone connection with the user, as shown in steps 228 and 210 (after moving from FIG. 2A to 2C by transitioning from point 291 to point 293 or moving from FIG. 2B to 2C by transitioning from point 295 to 297).

Upon verifying the entered PIN number as being the PIN number of the verified telephone number, the IVR system audibly provides the last known location for the GPS-enabled cell phone 112 having the verified telephone number, along with the time and date that the last known location was determined and the traveling speed, for some embodiments, as shown in step 232. To provide the location information as an audible voice message that is received from a user's telephone, the IVR system 134 utilizes text-to-voice technology. In this way, the GPS data provided by the GPS receiver 112 is translated to speech and delivered as a spoken report by the IVR system 134 to the user. Thus, the IVR system 134 can promptly or “instantaneously” report, in some embodiments, (as a spoken report) the interpolated speed, location and directional information from a location-based network 110 to any user who uses a telephone (land line or cell) to call a toll-free number provided by the driver monitoring program. This is significant, because now the user does not have to have access to a computer or have a compatible GPS cell phone (in range of a cell tower) to receive this data. The user can receive location information in real time, by making a phone call from any location, using any phone device. Further, because the report is a spoken text report, it is preferred to any other form of the reported data for many users (e.g. anyone who is blind or visually impaired, even if they have access to other reporting devices) and arguably better than map display reports for many users.

Referring back to the process of FIGS. 2A-2C, after a user receives the desired location information, the IVR system 134 prompts the user to end the call or to have the information repeated again (by speaking or pressing “1” or “2”), as shown in steps 234-238. If the user has chosen to end the call, the IVR system 134 provides a spoken message thanking the user and providing instruction for directing a transfer to a live operator, as shown in steps 240-244 (after moving from FIG. 2B to 2C by transitioning from point D/2C (289) to D/2B (299)), before the call is terminated, as shown in step 210.

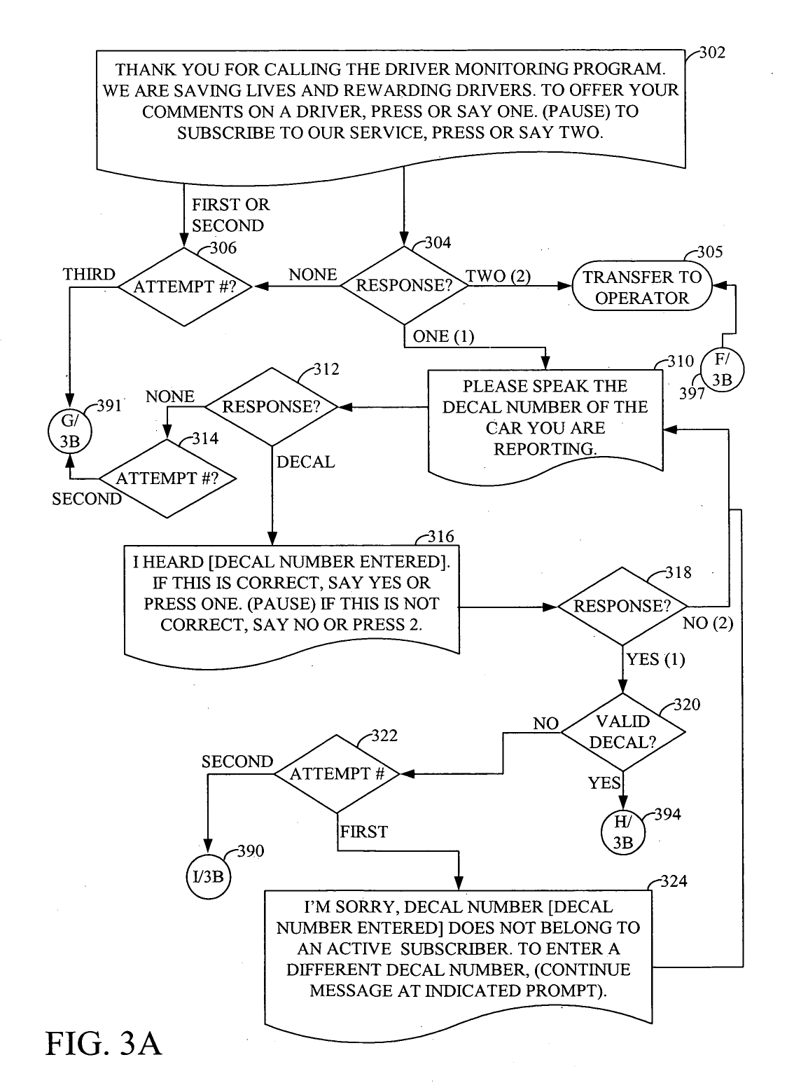

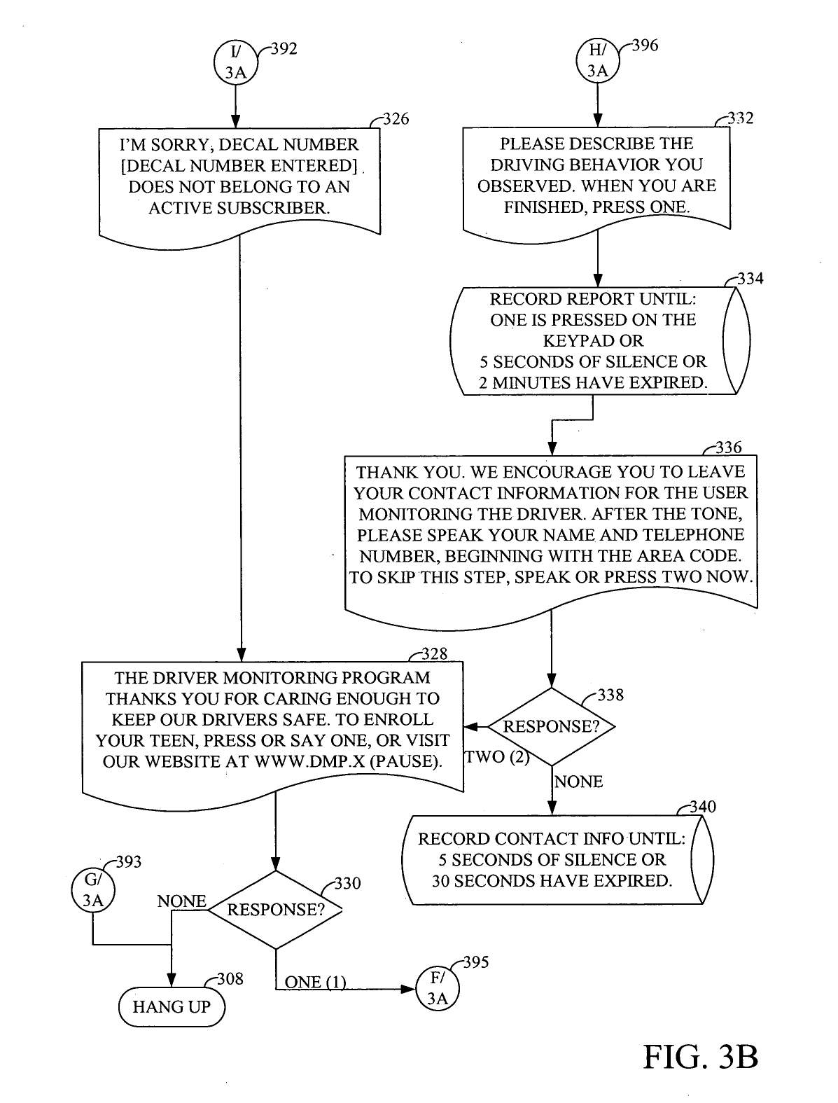

Next, FIGS. 3A-3B describe one embodiment, among others, of a process for making a report using the LBS system 100. First, in step 302, a call is received by the IVR system 134, and the IVR system 134 responds by playing an audio greeting to the caller. The audio greeting welcomes the caller and prompts the caller to either choose to offer comments on a driver having a decal of the driver monitoring program (by pressing or saying “1”) or to inquire about subscribing to the driver monitoring program (by pressing or saying “2”). If the caller chooses to inquire about subscribing to the driver monitoring program, the IVR system 134 transfers the call to an operator, as shown in steps 304-305. Alternatively, if there is no response from the caller, the initial audio greeting is played again, for a first or second failed attempt, or the system hangs up, for a third failed attempt, as shown in steps 306 and/or 308 (after transitioning from point G/3B (391) in FIG. 3A to point G/3A (393) in FIG. 3B). Otherwise, if the response indicates that the caller would like to comment about a driver having a program decal, the IVR system 134 prompts the user to vocally state (or use a telephone keypad to enter) the decal number of the car, as shown in step 310. The IVR system 134 then waits for a response from the caller. If the caller fails to respond, the IVR system 134 gives the caller another opportunity to provide the decal number before the IVR 134 system hangs up on the caller, as shown in steps 312, 314, and 308. Alternatively, if the caller provides a decal number, the IVR system 134 repeats the decal number received from the caller and asks the caller to state whether the received decal number is correct (by saying “yes” or by pressing “1”) or incorrect (by saying “no” or by pressing “2”), as shown in step 316.

If the received decal number is not the number the caller intended to specify, the IVR system 134 prompts the user to specify the decal number again, in step 318. For a correct response, however, the IVR system 134 attempts to verify that the decal number is a valid decal number currently in use by a customer (e.g. a participant driver) of the driver monitoring program, as indicated by step 320. If the IVR system 134 is unable to verify the decal number provided by the caller, the IVR system 134 notifies the caller that the decal number does not belong to an active subscriber and asks for the caller to enter the decal number again, for a first failed attempt, as shown in steps 322-324. Otherwise, the IVR system 134 notifies the caller that the decal number is invalid; thanks the caller for his or her time; and asks the caller if he or she would like to become a member of the program (by saying or pressing “1”, for example), as shown in steps 322 and 326-228 (after moving from FIG. 3A to 3B by transitioning from point I/3B (390) to point I/3A (392)). If the caller does not respond, then the IVR system 134 hangs-up (308). Alternatively, the IVR system 134 can connect the caller to an operator to discuss becoming a member of the driver monitoring program, as shown in steps 330 and 305 (after transitioning from point F/3A (395) in FIG. 3B to point F/3B (397) in FIG. 3A).

For a decal number that has been verified to belong to an active member of the driver monitoring program, the IVR system 134 prompts the caller to leave a spoken report of the behavior that the caller observed that is to be recorded by the IVR system 134. Accordingly, the caller is directed to press “1” when the caller has finished stating the description, as shown in step 332 (after moving from FIG. 3A to 3B by transitioning from point H/3B (394) to point H/3A (396)). Correspondingly, the IVR system 134 records the spoken report until (a) the user has pressed “1”; (b) 5 seconds of silence occurs; or (c) after 2 minutes have expired, as indicated in step 334. After the spoken report has been received, the IVR system 134 thanks the caller for his or her cooperation and invites-the caller to leave his or her contact information, including the caller's name and telephone number, as shown in step 336. The caller is also provided the opportunity to decline to leave contact information by pressing “2.”

If the IVR system 134 receives a command from the user to forego providing contact information, the IVR system 134 then thanks the caller for his or her time and invites the caller to enroll in the driver monitoring program (by pressing “1”) before terminating the phone call, as shown in steps 338, 328, 330, and 308. Alternatively, if the IVR system 134 does not receive a command from the caller to forego providing contact information, the IVR system 134 records the caller's contact information until there is 5 seconds of silence or 30 seconds have expired, as shown in step 340.

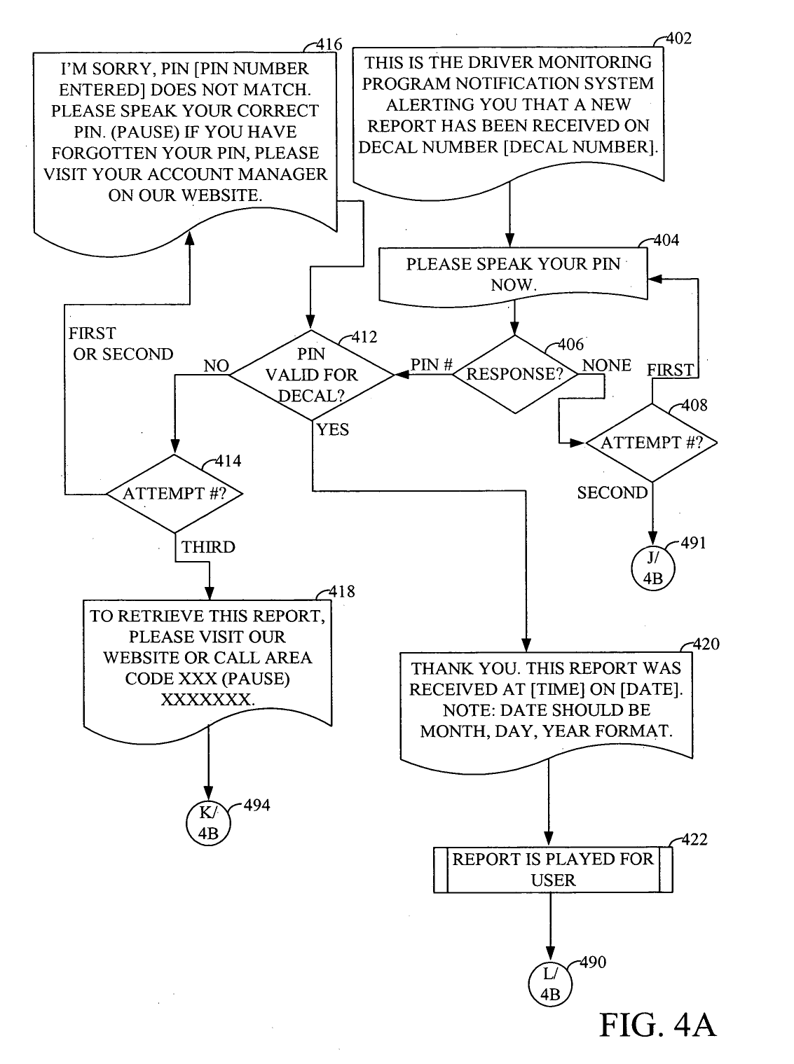

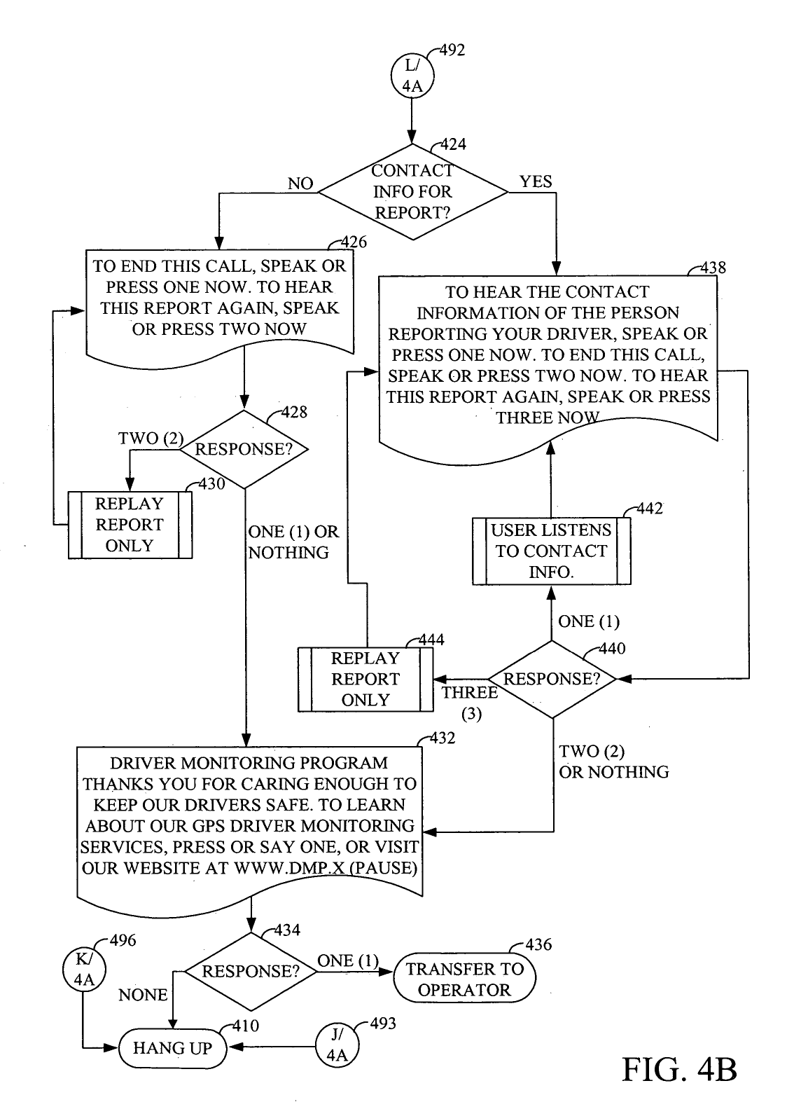

Next, FIGS. 4A-4B provides a flowchart describing one embodiment, among others, of a process for notifying a user that a report has been received for a decal number of the user. In this process, after the IVR system 134 receives a report commenting on the driving behavior of someone driving an automobile with an active decal, the IVR system 134 promptly calls the owner (e.g., user of the driver monitoring program, such as a parent) of the active decal at a telephone number listed in the user's account. Accordingly, in step 402, after the telephone connection has been established, the IVR system 134 plays a message notifying the person or device (“called party”) answering the telephone call that a new report has been received on a particular decal, as shown in step 402. Then, the IVR system 134 prompts (404) the called party to vocally provide the PIN number associated with the particular decal and user account.

If the called party fails to respond, either the IVR system 134 prompts (406, 408, 404) the called party to vocally provide the PIN number again (for a first failed attempt) or terminates (406, 408, 410) the connection (for a second failed attempt) (after transitioning from point J/4B (491) in FIG. 4A to point J/4A (493) in FIG. 4B). Alternatively, if the called party responds with a PIN number, the IVR system 134 attempts to authorize (406, 412) the PIN number as being valid for the decal number. If the IVR system 134 cannot authorize the entered PIN number as being a valid PIN number for the decal number, the IVR system 134 notifies the called party that the PIN number provided by the called party is incorrect and prompts (414-416) the called party to provide the PIN number again, for a first or second failed attempt. Otherwise, the IVR system 134 notifies the called party to attempt to retrieve the report by visiting a website for the driver monitoring program or by calling a specified phone number of the program, before terminating the telephone connection, as shown in steps 414, 418, and 410 (after transitioning from point K/4B (494) in FIG. 4A to point K/4A (496) in FIG. 4B).

For a validated PIN number, the IVR system 134 audibly provides (420) the date and time the new report was received and plays (422) the spoken report for the user. Then, the IVR system 134 checks in step 424 (after moving from FIG. 4A to 4B by transitioning from point L/4B (490) to point L/4A (492)) for contact information for the person that provided the new report. If contact information is not available, the IVR system 134 prompts the called party to choose to either end the call (by pressing or saying “1”) or to hear the spoken report again (by pressing or saying “2”), as indicated in step 426. If the called party elects (428) to hear the report again, the IVR system 134 plays (430) the spoken report and then prompts (426) the called party to end the call or to choose to have the report played again. If the called party elects (428) to end the telephone call, the IVR system 134 plays (432) an audio message thanking the called party and informs the called party of sources for additional information about the driver monitoring program, such as a website hosted by the driver monitoring program, or assistance from an operator (by pressing “1”). Accordingly, the IVR system 134 either hangs up (410) or terminates the telephone call or transfers (436) the called party to the operator based upon the response (434) from the called party.

If contact information is available, the IVR system 134 audibly asks (438) the called party if he or she would like to be provided with contact information of the person who made the report. The IVR system 134 also audibly asks the called party to confirm the selection by saying or pressing “1”, as indicated in step 438. Alternatively, the IVR system 134 prompts the called party to say or press “2”, if the called party would prefer to end the telephone call; and to say or press “3” if the called party would prefer to have the spoken report played again, as indicated in step 438.

If the called party chooses in step 440 to listen to the contact information, the IVR system 134 plays (442) the message containing the contact information. Alternatively, if the call party chooses (440) to have the spoken report played again, the IVR system 134 replays (444) the report. Otherwise, the 134 system plays (432) an audio message thanking the called party and informs the called party of sources for additional information about the driver monitoring program, such as a program website, or assistance from an operator (by pressing “1”). Accordingly, the IVR system 134 either hangs up (410) or terminates the telephone call or transfers (436) the called party to the operator based upon the response (434) from the called party.

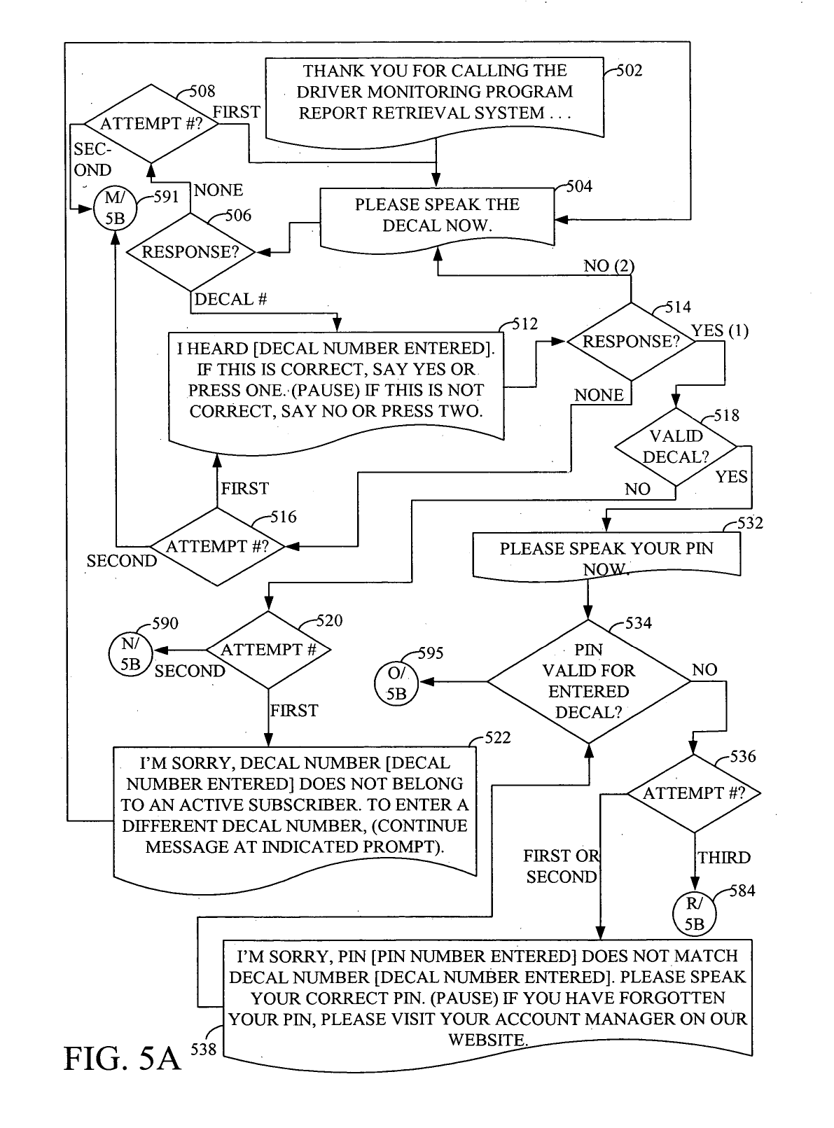

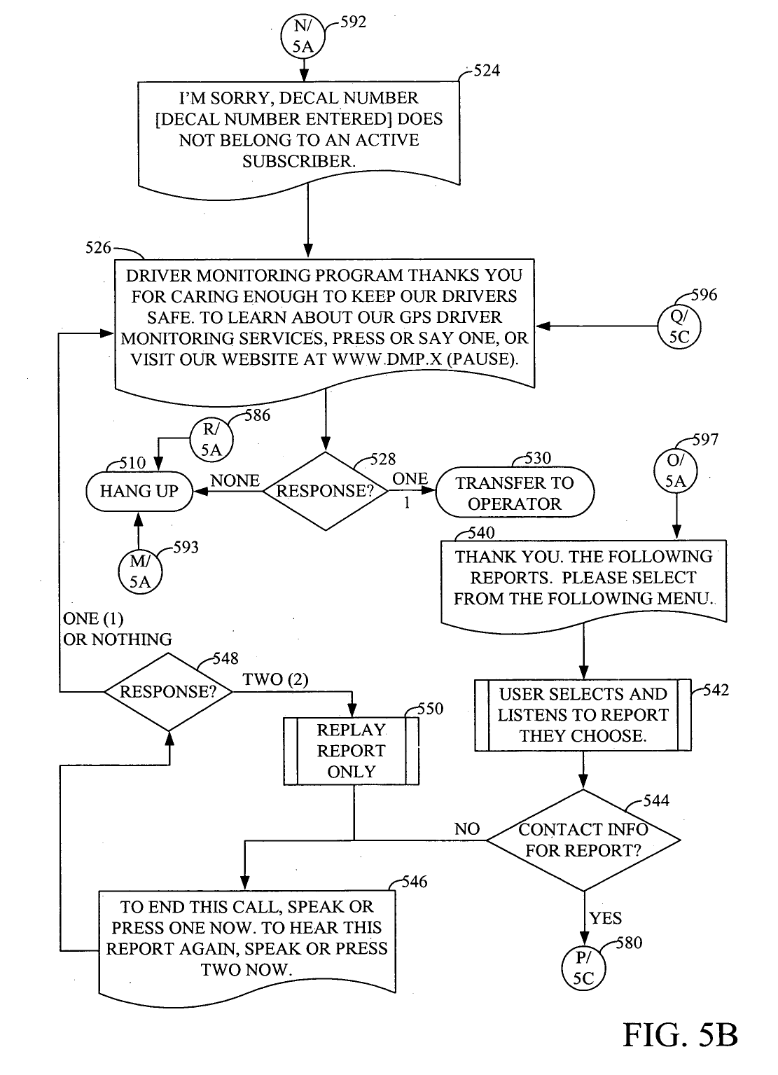

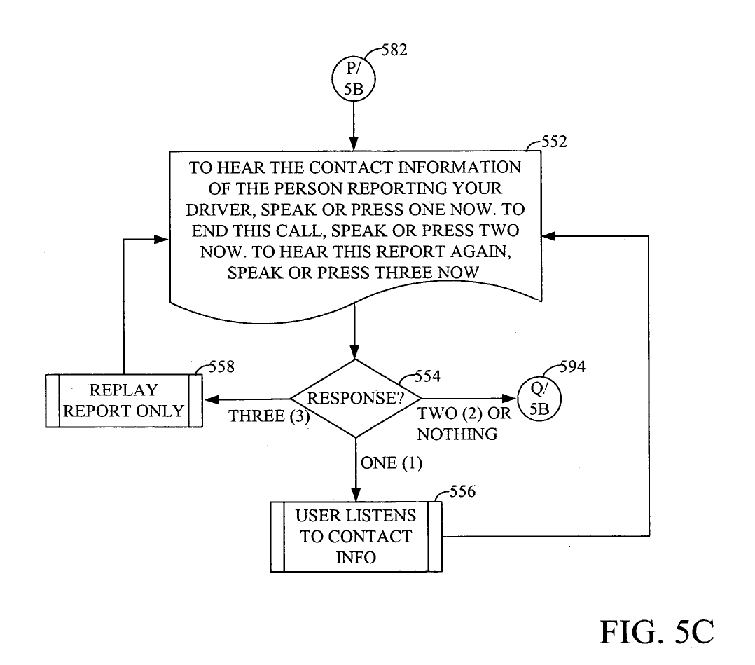

Referring now to FIGS. 5A-5C, a set of flowcharts describing one embodiment, among others, of a process for requesting a report is described. In this process, a user of the driver monitoring program calls a toll-free telephone number of the driver monitoring program in order to retrieve spoken reports that have been previously left for the user. As such, the IVR system answers the call and thanks (502) the user for calling the retrieval system for the driver monitoring program. The IVR system then proceeds to prompt (504) the user to vocally provide the decal number associated with the user. The IVR system 134 waits for the response (506) and if there is no response (508), the IVR system 134 either prompts (504) the user to provide the decal number again, for a first failed attempt; or ends (in step 510, after moving from FIG. 5A to 5B by transitioning from point M/5B (591) to point M/5A (593)) the telephone connection for a second failed attempt.

If a response is received (506), the IVR system 134 repeats (512) the received decal number to the user and asks the user to confirm that the decal number has been correctly received (by pressing “1” or saying “yes”) or incorrectly received (by pressing “2” or saying “no”). If the response from the user indicates (514) that the decal number was incorrectly received, the IVR system 134 prompts (504) the user to repeat the decal number. Alternatively, if the user fails to respond (514) in a sufficient manner, the IVR system 134 asks the user to confirm (512) whether the received decal number is correct, if this is a first failed attempt (516); or the IVR system 134 ends (510) the telephone connection, if this is a second failed attempt (516). For a response that confirms that the received decal number is correct, the IVR system 134 attempts to validate (518) the decal number by checking to verify that an active customer of the driver monitoring program is registered with the decal number.

If the IVR system 134 cannot validate the decal number, the IVR system 134 either (a) notifies (522) the user that the decal number does not belong to an active member and asks (522, 504) the user to provide a different decal number, if this is a first failed attempt (520) at validating the decal number; or (b) the IVR system 134 notifies in step 524 (after moving from FIG. 5A to 5B by transitioning from point N/5B (590) to point N/5A (592)) the user that the decal number is not valid; thanks (526) the user for calling; and informs (526) the user that additional information can be obtained by visiting the driver monitoring program website or by pressing or saying “1” to speak with an operator. If the user responds (528) by electing to speak with an operator (by pressing or saying “1”), the IVR system 134 transfers (530) the telephone call to the operator. Otherwise, the IVR system 134 hangs up (510).

For a decal number that has been validated, the IVR system 134 prompts (532) the user to vocally provide (or provide with a telephone keypad) the user's PIN number. The IVR system 134 then attempts to validate (534) the PIN number provided by the user with the PIN number registered with the decal number. If the PIN number is not validated (536), the IVR system 134 either (a) notifies (538) the user that the PIN number provided by the user does not match the PIN contained in the user's records and asks (538) the user to provide the PIN number again, for a first or second failed attempt at providing the correct PIN number; or (b) the IVR system 134 terminates (in step 510, after moving from FIG. 5A to 5B by transitioning from point R/5B (584) to point R/5A (586)) the telephone connection for a third failed attempt at providing the correct PIN number for the decal number.

After validating the PIN number, the IVR system 134 thanks (in step 540, after moving from FIG. 5A to 5B by transitioning from point O/5B (595) to point O/5B (597)) the user and audibly provides (540) a menu of choices from which the user can choose. For example, the IVR system 134 may prompt the user to say or press “1” to hear the most current report; to say or press “2” to hear the second most current report, and so on. Accordingly, the user selects the particular report that user wants to listen to and then the report is played (542) for the user. After the playing of each report, the IVR system 134 checks (544) for contact information that has been made available for the report. If no contact information is available, the user is prompted (546) to end the telephone call by speaking or pressing “1”; or to listen to the report again by speaking or pressing “2”. If a response (548) is received to end the call, the IVR system 134 thanks (526) the user for calling; and informs (526) the user that additional information can be obtained by visiting the program website or by pressing or saying “1” to speak with an operator.

If the user responds (528) by electing to speak with an operator (by pressing or saying “1”), the IVR system 134 transfers (530) the telephone call to the operator. Otherwise, the IVR system 134 hangs up (510). Alternatively, if a response (548) is received directing the IVR system 134 to replay the report, the IVR system 134 plays (550) the report again. Then, the IVR system 134 prompts (546) the user to end the call or to replay the report again.

For the situation where contact information is available for a report that has been played to the user, the user is prompted (in step 552, after moving from FIG. 5B to 5C by transitioning from point P/5C (580) to point P/5B (582)) to choose whether to hear the contact information (by speaking or pressing “1”); to end the call (by speaking or pressing “2”); or to listen to the report again (by speaking or pressing “3”). If the user responds (554) by choosing to listen to the contact information, the IVR system 134 plays (556) the contact information for the user. Alternatively, if the user responds (554) by choosing to replay the report, the IVR system 134 plays (558) the report again for the user. Otherwise, if the user fails to respond (554) appropriately, the IVR system 134 thanks (526) the user for calling; and informs (in step 526, after moving from FIG. 5C to 5B by transitioning from point 594 to point 596) the user that additional information can be obtained by visiting the program website or by pressing or saying “1” to speak with an operator. If the user responds (528) by electing to speak with an operator (by pressing or saying “1”), the IVR system 134 transfers (530) the telephone call to the operator. Otherwise, the IVR system 134 hangs up (510).

Some embodiments, among others, of the driver monitoring program also incorporate a “Rewards Program” component. For example, participant drivers who receive random or planned calls from the driver monitoring program who have GPS enabled cell phones 112 in use when they are called are eligible for points and rewards. Since a GPS enabled cell phone will only report data if it is “on”, this encourages use of the cell phone by those who are being “monitored” by it. Further, some embodiments of the rewards program award participant drivers with good driving behavior.

One point system for awarding points in one embodiment, among others, of the reward program is as follows: Participants are given 10 points for registering in the program. These points are awarded in recognition of that participant's commitment to driving safely. For each month the participant drives without a negative report, he/she receives 10 additional points. Points are cumulative and are not “spent” when rewards are received or won. The only way a participant loses points is in the event that he/she receives a negative report. Complimentary reports do not cost the participant driver any points. Once a participant driver reaches a certain level of points (i.e. 50 points=eligible for computer drawing), he or she can register each and every month for a computer or some other type of reward that is being offered. However, there may be limitations such that a participant is only eligible to win one item per type. Further, a participant may be able to directly redeem points for a particular reward (e.g., a music compact disc) without having to enter into a drawing. Should a driver receive negative report, the driver loses a percentage of his/her accumulated points and is not be eligible for the next rewards drawing. While not eligible for the drawings during this 30 day wait period, the driver still is able to earn points for safe driving. The following schedule, for example, may be used:
1st report: lose 50% of total outstanding points, excluding bonus points
2nd report: lose 75% of total outstanding points, excluding bonus points
3rd report: lose 100% of total outstanding points, excluding bonus points

For each 12 month period the participant drives without a negative report, he/she receives 30 bonus points. These points are not subject to loss in the event of future reports. Subscribers (e.g., parents or guardians) are given input on expunging negative reports based on prank calls. For example, by default, all reports are listed as “complaint calls” by the LBS system. However, if a report is actually a prank or a complimentary report, the user (e.g., parent) may, at his or her sole discretion, access the user's account manager (from the monitoring program website) and change the designation of the call. With use of the rewards program, participants are positively reinforced for good driving behavior. In some embodiments, the driver monitoring program sends participants a newsletter each month, which provides information about that month's rewards, to every participant driver and subscriber.

Various components of embodiments of the present disclosure can be implemented in hardware, software, firmware, or a combination thereof. For example, some components may be stored in a memory and executed by a suitable instruction execution system, if implemented in software or firmware. If implemented in hardware, some components may also be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments of the present disclosure, are merely possible examples of implementations, merely set forth for a clear understanding of the principles of the disclosure. Many variations and modifications may be made to the above-described embodiments of the disclosure without departing substantially from the spirit and principles of the disclosure. For example, in some embodiments, a user can also log into a website of the driver monitoring program; select to locate a participant driver; and the LBS system locates the participant driver and displays the location and location history of the participant driver to the user. As stated above, hardware devices reporting information to navigational or information systems may report many forms of information in addition to speed, location, and direction of travel, such as automotive diagnostic data, among others. All such modifications and variations are intended to be included herein within the scope of this disclosure.

The following is claimed:

1. A system for monitoring a driver of a vehicle, comprising:
a first reporting means for receiving a communication from a person regarding the driving behavior of the driver of the vehicle; and
a second reporting means for delivering the communication to a user monitoring the driving behavior of the driver.

2. The system of claim 1, wherein the second reporting means is configured to deliver a current location of the driver to the user.

3. The system of claim 1, wherein the second reporting means is further configured to notify the driver of the communication regarding the driving behavior of the driver.

4. The system of claim 1, wherein the first reporting means comprises an interactive voice response unit that is accessible over landline based telephone systems.

5. The system of claim 1, wherein the second reporting means comprises an interactive voice response unit that is accessible over landline based telephone systems.

6. The system of claim 1, wherein the second reporting means comprises an e-mail delivery system.

7. The system of claim 1, wherein the second reporting means comprises a web-based reporting system.

8. The system of claim 1, further comprising:
a monitoring means for monitoring a location of the vehicle and reporting the location to a database unit that is accessed by the first reporting means and the second reporting means.

9. The system of claim 1, wherein the monitoring means comprises a GPS-enabled communication device.

10. A method for monitoring a driver of a vehicle, comprising the steps of:
receiving a driving report on the driver of the vehicle from a person observing the driver, the driving report including a description of the driving behavior of the driver; and
delivering the driving report on the driver to a user monitoring the driver.

11. The method of claim 10, further comprising the step of:
promptly notifying the user of a new driving report after the new driving report is received.

12. The method of claim 10, further comprising the step of:
monitoring a current location of the driver;
storing the current location in a database; and
enabling the user to access the current location of the driver from the database.

13. The method of claim 12, further comprising the step of:
monitoring a current speed of a vehicle being driven by the driver;
storing the current speed in the database; and
enabling the user to access the current speed of the driver from the database.

14. The method of claim 10, further comprising the step of:
enabling the user monitoring the driver to contact the person that provided the driving report on the driver.

15. The method of claim 10, further comprising the step of:
providing the driver a monitoring device to monitor the current location of the driver; and
randomly checking the monitoring device to determine if the device is on.

16. The method of claim 15, further comprising the step of:
awarding a reward to the driver if the monitoring device is on when it is randomly checked.

17. The method of claim 10, further comprising the step of:
awarding reward points to the driver for good driving behavior, wherein the reward points may be directly redeemed for a particular reward prize if the reward points are at a particular level.

18. The method of claim 10, further comprising the step of:
awarding reward points to the driver for good driving behavior, wherein the reward points may be used to enter the driver into a drawing for a reward prize.

19. The method of claim 10, further comprising the steps of:
awarding reward points to the driver for good driving behavior; and
deducting reward points from the driver with bad driving behavior.

20. The method of claim 19, further comprising the step of:
informing the driver of the status of the reward points of the driver and of the status of reward points of other participating drivers being monitored.
